(19) United States
(12) Patent Application Publication
(10) Pub. No.: US 2006/0114584 A1
(43) Pub. Date: Jun. 1, 2006

(54) Method for coating leather

(76) Inventor: Pietro Balestra, Bassano del Grappa (IT)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/329,488

(22) Filed: Jan. 11, 2006

(30) Foreign Application Priority Data
Jul. 22, 2003 (IT) PD20030168
Jul. 13, 2004 (EP) 1500711

(51) Int. Cl. G02B 5/04

(52) U.S. Cl. 359/833

(57) ABSTRACT

A method for coating leather with a metallic film, includes the steps of placing a piece of leather in a vacuum environment; cleaning at least one surface of the piece of leather and of the vacuum environment by a glow discharge; forming a metallic film by a thermoforming process; and eliminating the vacuum.

### BACKGROUND

1. Technical Field

The present invention relates to a method for coating leather or the like by means of a metallic film.

2. Description of the Related Art

The art of reducing gold to extremely thin sheets in order to decorate items, paintings, fabrics and leather has been widespread since antiquity.

This art was practiced in particular in Solfora according to a method known as “oropelle”, which consisted of gluing gold leaf to leather.

Thus decorated, leather was used for bookbinding, for harnesses for horses and riders, and for various ornaments both in clothing and in interior decoration of homes, palaces and churches.

The gold underwent a first process for reducing its thickness in a rolling-mill, where strips with a thickness of one millimeter were formed.

These strips were cut into individual pieces, which were joined in layers and beaten by hammering on an anvil until they reached the thickness of a sheet of paper.

At this point, the sheets were stacked again, inserting rectangles of finely tanned hide between one sheet and the next.

The resulting pack was inserted in a parchment sheath and subjected to a second beating.

The sheets thus reduced in thickness were then placed again between hide membranes and hammered.

This process was repeated several times.

During the last hammerings, the sheets were placed between thin membranes made in particular with the intestine of animals, so that the gold could be further beaten with very gentle blows.

Once the thickness reduction operation was completed, the sheets could reach a thickness of less than one thousandth of a millimeter.

An updated technique, in which extremely thin layers of gold are glued to the leather in order to embellish it or decorate it, is still practiced today.

Next to this ancient art, more sophisticated methods have been developed recently in order to allow providing gold decorations on leather capable of withstanding many bending operations without forming cracks or fissures.

For example, JP-11129392 discloses a method for coating leather with a layer of gold by laminating simultaneously on the leather a film of soft plastic material together with a metallic gold film.

There are also many methods for embossing and stamping gold leafs on leather, such as for example the one described and claimed in U.S. Pat. No. 1,547,663.

However, these techniques have proved to be rather complicated, onerous and not free from drawbacks.

In particular, currently the aesthetic effect obtained by associating a gold leaf with a piece of leather, for example by gluing, does not achieve an entirely satisfactory aesthetic effect, since the gold leaf tends in any case to appear as a separate element with respect to the leather.

Moreover, in most cases the resulting decorated leather is easily subject to wear and deterioration in its gold layer.

### SUMMARY

The present method is designed to be used advantageously in goldsmithing, in the field of production of items of clothing made of leather, shoes or items of any kind made of leather, synthetic leather, tanned hide or similar materials.

The aim of the present invention is to solve the described problems, eliminating the drawbacks of the cited prior art, by providing a method for coating leather or the like, particularly with precious metal having a uniform thickness, which is mechanically extremely strong and aesthetically appreciable.

Within this aim, an object of the present invention is to provide a method that is particularly simple, low in cost and entirely reliable.

This aim and this and other objects that will become better apparent hereinafter are achieved by a method for coating leather or the like with a metallic film, characterized in that the method comprises the steps of:

placing a piece of leather or the like in a vacuum environment;

cleaning at least one surface of said piece of leather or the like and of the vacuum environment by means of a glow discharge;

forming a metallic film by means of a thermoforming process; and

eliminating the vacuum.

Advantageously, the method can provide, before placing said leather or the like in a vacuum environment, for the optional application of a first surface coating on said leather or the like by lacquering.

Conveniently, the method can provide, after vacuum elimination, for the optional application of a second protective surface coating on said film.

A product, and therefore a piece of leather, is thus obtained that can be processed subsequently so as to obtain the intended end product, such as a bracelet, belt, shoe or other item, which has on at least one surface a film of noble metal or alloys with a thickness on the order of nanometers.

The film is formed by means of a thermoforming process, which provides for example for the thermospraying of one or more metallic powders that comprise gold, sliver, aluminum, zinc, nickel, copper, cobalt, chromium, titanium, platinum and/or alloys and/or derivatives thereof.

These and other objects, features and advantages will become apparent from the following detailed description of illustrative embodiments thereof, which is to be read in connection with the accompanying drawings.

### BRIEF DESCRIPTION OF DRAWINGS

Further characteristics and advantages of the present invention will become better apparent from the following detailed description of particular but not exclusive embodiments thereof, illustrated by way of non-limiting example in the accompanying drawings, wherein:

FIG. 1 is a schematic view of the deposition of the metallic film by way of the Joule effect;

FIG. 2 is a schematic exemplifying view of a stratigraphic cross-section of the product obtained with the method.

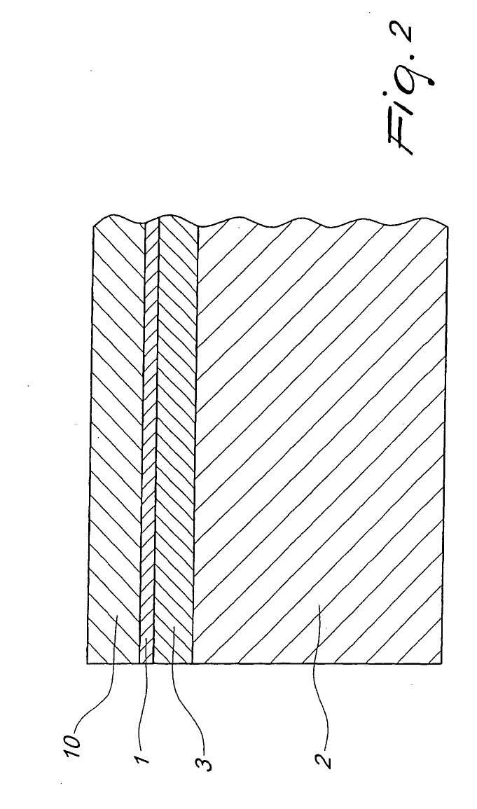

### DETAILED DESCRIPTION OF PREFERRED EMBODIMENTS

In the embodiments that follow, individual characteristics, given in relation to specific examples, may actually be interchanged with other different characteristics that exist in other embodiments.

Moreover, it is noted that anything found to be already known during the patenting process is understood not to be claimed and to be the subject of a disclaimer.

With reference to the figures, a method according to the present invention is suitable for use in the goldsmithing sector to obtain a coating, by means of the application of a metallic film, designated by the reference numeral 1, with a decorative value, for example on a piece of leather, designated by the reference numeral 2, or on leather or synthetic leather or on similar materials in sheet form.

Hereinafter, therefore, the term “leather” will be used to designate equally, unless otherwise specified, any natural or synthetic product that can be used traditionally like leather and therefore both in the field or the clothing industry and in the shoemaking field, in the interior decoration field, or in any other provided field.

Once the leather 2 has been prepared with the chosen degree of surface finish, the method provides for an optional application of a first surface coating, designated by the reference numeral 3, on the leather 2 or the like by lacquering, in order to improve the quality of the deposition of the metallic film.

The first surface coating 3 of the leather 2 can be obtained by means of a resin, chosen among acrylic resins, polyurethane resins, butadiene resins, or among polyvinyl bonding agents.

The method then provides for positioning the leather 2 or the like in an environment placed in vacuum (vacuum environment), followed by a step for cleaning at least one surface of the leather 2 or the like, optionally after applying the first protective layer 3, and of the vacuum environment by means of a process known as glow discharge.

It is therefore possible to use, for this purpose, a radio frequency antenna, which captures the impurities that are present.

The method therefore provides for the thermoforming of the metallic film 1 by means of a process for thermospraying one or more metallic powders or metals that are originally available in other forms.

Such powders may include one or more of gold, silver, aluminum, zinc, nickel, copper, cobalt, chromium, titanium and/or alloys and/or derivatives thereof.

The expression “thermospraying process” is used to designate any coating process that brings metals, available in the form of powders, filaments, wires or fragments, to the state of molten particles (metallic vapors), which can be accelerated toward the leather 2, or optionally the first surface coating 3, where they solidify rapidly, forming the film 1, which has a substantially laminar structure.

When the molten particle reaches the leather 2 or optionally the first surface coating 3, it flattens due to its own kinetic energy, producing a small lamina.

The mutual overlap of the individual laminas then forms the film 1.

Up to now, thermospraying processes have been used notoriously only on rigid materials such as plastics or metals, and mainly for the purpose of obtaining surfaces that have an exceptional resistance to wear, abrasion, corrosion or thermal stresses.

Surprisingly, it has been found that this thermospraying process could be adapted usefully and in an original manner also for the production of a coating layer on leather, particularly once it has been prepared with a surface treated in a particular manner.

Accordingly, the possibility to deposit a film or layer of metal, particularly precious metal, on leather opens many, possibilities of application, particularly in the field of fashion or interior decoration.

Advantageously, moreover, it has been found that a performance is achieved that is particularly appreciable in terms of quality and mechanical strength of the resulting coating by using a particular method that uses charge migration or the Joule effect, by means of a method known as “plasma spray”, with a powder deposition pressure that is lower than atmospheric pressure, preferably comprised in the range between 10⁻² and 10⁻⁷ torr and particularly in the neighborhood of 10⁻⁵ torr.

Moreover, it is possible to use devices, such as for example the one known as a “magnetron”, which produces a pulverization of the metal that is transferred onto the leather or the like.

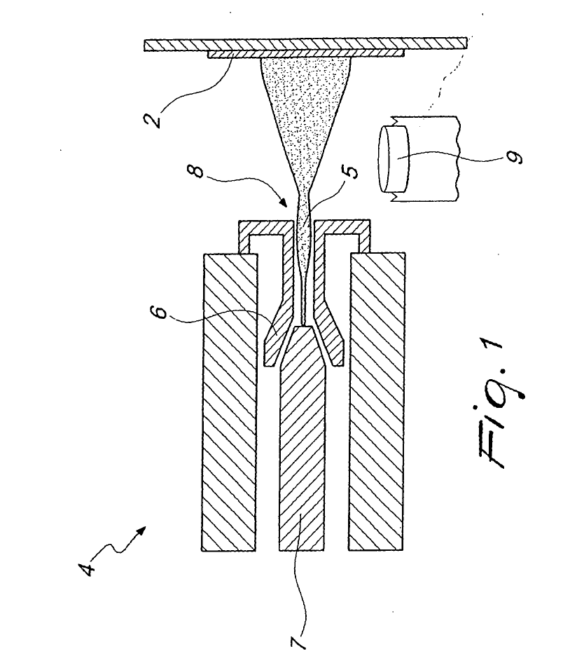

In accordance with the exemplifying diagram of FIG. 1, the reference numeral 4 designates a device for performing thermospraying; this method uses plasma as a medium for accelerating the particles.

The state of plasma 5 (free electrons, ionized atoms and neutral atoms) is generated by means of a DC voltaic arc produced between two electrodes, designated by the reference numerals 6 and 7.

The adjustments of the current and voltage depend, among other things, on the geometry of the electrodes and on the flow and composition of the gas.

The anode 6 of the device 4 for producing the plasma sprays is preferably made of copper while the cathode 7 is made of tungsten.

The plasma-generating gas that is used can be hydrogen, nitrogen, argon, helium or another noble gas or even simply air.

The gas flows into the annular duct in which the arc is triggered, producing the outflow, through an appropriately provided nozzle 8, of a flow or jet of gas as plasma at an extremely high temperature.

The temperature (normally comprised between 10000 and 15000° C.) and the rate of flow of the plasma thus created depend, among other things, on the speed and density of the stream of gas in input, on the configuration of the electrodes 6 and 7, and on the electric power used in the arc.

The metal chosen for the coating is brought to the melting temperature and then introduced in the jet of molten particles (preferably by means of a carrier gas) In order to be conveyed against the leather 2, or optionally the first surface coating 3, to be coated.

The metal can be heated by way of the plasma 5 or by Joule heating, for example in an appropriately provided titanium chamber 9.

The distance between the nozzle 8 and the leather 2 or optionally the first surface coating 3 is determined as a function of the type of metal coating to be provided.

Advantageously, the leather or optionally the first surface coating 3 can vary its position to allow a uniform deposition of the molten particles on the surface of the leather 2 or of the first surface coating 3.

The angle of incidence for deposition of the molten particles on the leather or on the first surface coating 3 can be adjusted advantageously by varying the position of the leather 2.

The method then provides for elimination of the vacuum.

Moreover, in order to protect the metallic film 1 obtained by plasma spray forming against possible oxidations or simply against wear, provision is advantageously made for the application of a second surface coating 10 by means of a new layer of resin.

The resin used to obtain both the first surface coating and the second surface coating can be advantageously the same and can be constituted preferably by a two-part polyurethane resin.

Finally, it is noted that the resulting leather decorated with the metallic film can be subjected to conventional stamping treatments adapted to give its surface particular grains, patterns or aesthetic effects in general.

It has thus been found that the method has achieved the intended aim and objects, allowing to obtain a product made of leather or the like that has, on at least one surface, a film of noble metal or alloys with a thickness on the order of nanometers.

The invention is of course susceptible to numerous modifications and variations, all of which are within the scope of the appended claims.

The materials used may of course be more pertinent according to specific requirements.

The various means for performing certain different functions need not certainly coexist only in the illustrated embodiment but can be present per se in many embodiments, including ones that are not illustrated.

The characteristics indicated as advantageous, convenient or the like may also be omitted or replaced by equivalents.

Moreover, the present invention can also assume, in its practical embodiment, shapes and configurations that are different from the one described above without thereby abandoning the present protective scope.

The disclosure in Italian Patent Application No. PD2003A000168 is commonly owned and incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

Having described preferred embodiments of a method for coating leather (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for coating leather or the like with a metallic film, comprising the steps of:
placing a piece of leather or the like in a vacuum environment;
cleaning at least one surface of said piece of leather or the like and of the vacuum environment by a glow discharge;
forming a metallic film by a thermoforming process; and
eliminating the vacuum.

2. The method according to claim 1, wherein, before placing said leather or the like in a vacuum environment, applying a first surface coating on said leather or the like by lacquering.

3. The method according to claim 2, wherein said first surface coating includes a resin.

4. The method according to claim 3, wherein the resin includes one of acrylic, polyurethane and butadiene resins or among polyvinyl bonding agents.

5. The method according to claim 2, wherein cleaning includes cleaning said first coating and the vacuum environment by glow discharge achieved by using a radio frequency antenna suitable to capture the impurities that are present.

6. The method according to claim 1, further comprising: after eliminating the vacuum, applying a second protective surface coating on said film.

7. The method according to claim 6, wherein said second surface coating includes a resin.

8. The method according to claim 7, wherein the resin includes one of acrylic, polyurethane and butadiene resins or among polyvinyl bonding agents.

9. The method according to claim 1, wherein forming includes forming on at least one surface, a film made of noble metal or alloys with a thickness on the order of nanometers.

10. The method according to claim 1, wherein cleaning includes cleaning at least one surface of said leather or the like and of the vacuum environment by glow discharge achieved by using a radio frequency antenna suitable to capture the impurities that are present.

11. The method according to claim 1, further comprising wherein the step of forming includes thermoforming said metallic film by thermospraying one or more metallic powders.

12. The method according to claim 11, wherein the one or more metallic powders includes at least one of gold, silver, aluminum, zinc, nickel, copper, cobalt, chromium, titanium, platinum or alloys or derivatives thereof.

13. The method according to claim 11, wherein thermospraying includes employing a charge transfer method or a plasma spray method, with a powder deposition pressure that is lower than the atmospheric pressure.

14. The method according to claim 13, wherein said powder deposition pressure includes an interval between 10⁻² and 10⁻⁷ torr.

15. The method according to claim 14, wherein said powder deposition pressure is substantially 10⁻⁵ torr.

16. The method according to claim 11, wherein thermospraying is obtained by means of devices in which the metal that is transferred onto the leather or the like is pulverized.

17. A product made of leather or the like, having, on at least one surface, a film made of noble metal or alloys with a thickness on the order of nanometers.

18. The product of claim 17, wherein the leather and the film include a coating disposed therebetween.

19. The product of claim 17, wherein the film includes a coating disposed thereon.
